(19) United States
(12) Patent Application Publication
(10) Pub. No.: US 2024/0300474 A1
(43) Pub. Date: Sep. 12, 2024

(54) HYBRID VEHICLE CONTROL SYSTEM AND METHOD FOR CONTROLLING HYBRID VEHICLE

(71) Applicant: TOYOTA JIDOSHA KABUSHIKI KAISHA, Toyota-shi (JP)

(72) Inventors: Hiroya CHIBA, Fuji-shi (JP); Takehiko HANADA, Hiratsuka-shi (JP); Tatsuya SUGANO, Sunto-gun (JP); Noriyuki TSURUOKA, Susono-shi (JP); Ryuji OKAMURA, Gotemba-shi (JP); Amane YAJIMA, Ashigarakami-gun (JP); Yuki OKAMOTO, Hadano-shi (JP)

(21) Appl. No.: 18/598,164

(22) Filed: Mar. 7, 2024

(30) Foreign Application Priority Data
Mar. 8, 2023 (JP) 2023-036019

(51) Int. Cl. B60W 20/20; B60W 10/06; B60W 10/08; B60W 30/182; B60W 60/00

(52) U.S. Cl. CPC B60W 20/20; B60W 10/06; B60W 10/08; B60W 30/182; B60W 60/001; B60W 2510/242; B60W 2520/00

(57) ABSTRACT

The present disclosure provides a hybrid vehicle control system for controlling a vehicle having a motor and an engine. The system executes the following processes. The first process is determining whether a situation which the vehicle is currently facing is a situation in which high accuracy is required for control of driving of the vehicle or not. The second process is selecting only an EV mode under a situation in which high accuracy is required for the control. The third process is selecting an engine activation mode only under a situation in which high accuracy is not required for the control. The EV mode is a mode in which the engine is stopped and the vehicle is driven by the motor. The engine activation mode is a mode in which the engine is activated for at least one of power generation for charging a battery and driving the vehicle.

### CROSS-REFERENCE TO RELATED APPLICATION

The present application claims priority under 35 U.S.C. § 119 to Japanese Patent Application No. 2023-036019, filed on Mar. 8, 2023, the contents of which application are incorporated herein by reference in their entirety.

### BACKGROUND

### Field

The present disclosure relates to a technique for controlling a hybrid vehicle.

### Background Art

JP 6020249 discloses a hybrid vehicle control device. The hybrid vehicle control device detects a travel route from a departure place to a destination and calculates an EV suitability (travel load) for each section on the travel route. Then, the hybrid vehicle control device makes a plan of a section for performing a EV traveling mode based on the EV suitability, energy consumption which is consumed during traveling, and a remaining amount of a battery.

Incidentally, JP2014-213638A, JP 4314257, and JP2021-123290A are exemplified in addition to the above JP 6020249 as documents showing the technical level in the technical field of the present disclosure at the time of applying.

### SUMMARY

A hybrid vehicle equipped with a motor and an engine is known. The hybrid vehicle has a plurality of drive modes and can travel in an engine activation mode, in which the engine is activated and can travel in an EV mode, in which the engine is stopped. The drive mode is generally switched in consideration of an amount of electric power to be consumed. However, the difference between the engine activation mode and the EV mode is not only the amount of electric power consumed during traveling. Making comparison between the engine activation mode and the EV mode, the EV mode may reduce an error in control of the vehicle and make control accuracy higher.

On the other hand, the control accuracy required for traveling of the vehicle is not always the same. Accuracy required for the control of the vehicle may vary depending on a situation of the traveling of the vehicle, environment around the vehicle, or the like. For example, it is expected that higher accuracy is required when the vehicle is being parked or traveling in a narrow road than when the vehicle is traveling in a straight road. Therefore, it is considered to utilize the EV mode more effectively by selecting the EV mode under a situation where high accuracy is required for the control.

The present disclosure provides a technique capable of utilizing the EV mode of the hybrid vehicle effectively by selecting the drive mode in accordance with a situation.

In order to achieve the above object, the present disclosure provides a hybrid vehicle control system for controlling a vehicle having a motor and an engine. The hybrid vehicle control system according to the present disclosure comprises at least one processor and at least one memory coupled with the at least one processor and storing a plurality of instructions. The plurality of instructions is configured to cause the at least one processor to execute the following processes. The first process is determining whether a situation which the vehicle is currently facing is a situation in which high accuracy is required for control of driving of the vehicle or not. The second process is selecting only an EV mode under a situation in which high accuracy is required for the control. The third process is selecting an engine activation mode only under a situation in which high accuracy is not required for the control. The EV mode is a mode in which the engine is stopped and the vehicle is driven by the motor. The engine activation mode is a mode in which the engine is activated for at least one of power generation for charging a battery and driving the vehicle.

In order to achieve the above object, the present disclosure also provides a method for controlling a hybrid vehicle having a motor and an engine. The method includes the following steps. The first step is determining whether a situation which the hybrid vehicle is currently facing is a situation in which high accuracy is required for control of driving of the hybrid vehicle or not. The second step is selecting only an EV mode under a situation in which high accuracy is required for the control. The third step is selecting an engine activation mode only under a situation in which high accuracy is not required for the control. The EV mode is a mode in which the engine is stopped and the hybrid vehicle is driven by the motor. The engine activation mode is a mode in which the engine is activated for at least one of power generation for charging a battery and driving the hybrid vehicle.

According to the technique of the present disclosure, a situation in which high accuracy is required for control of a vehicle is detected based on a current situation of the vehicle. An EV mode is selected in a scene where high accuracy is required for controlling the vehicle, and it is possible to effectively utilize the EV mode of a hybrid vehicle.

### BRIEF DESCRIPTION OF THE DRAWINGS

FIG. 1 is a block diagram showing an example of a configuration of a vehicle to which a hybrid vehicle control system according to a present embodiment is applied.

FIG. 2 is a block diagram showing an example of a configuration of the hybrid vehicle control system according to the present embodiment.

FIG. 3 is a flowchart showing the first example of a process executed by the hybrid vehicle control system according to the present embodiment.

FIG. 4 is a flowchart showing the second example of a process executed by the hybrid vehicle control system according to the present embodiment.

### DETAILED DESCRIPTION

Embodiments of the present disclosure will be described with reference to the accompanying drawings.

### 1. Description of Hybrid Vehicle Control Device

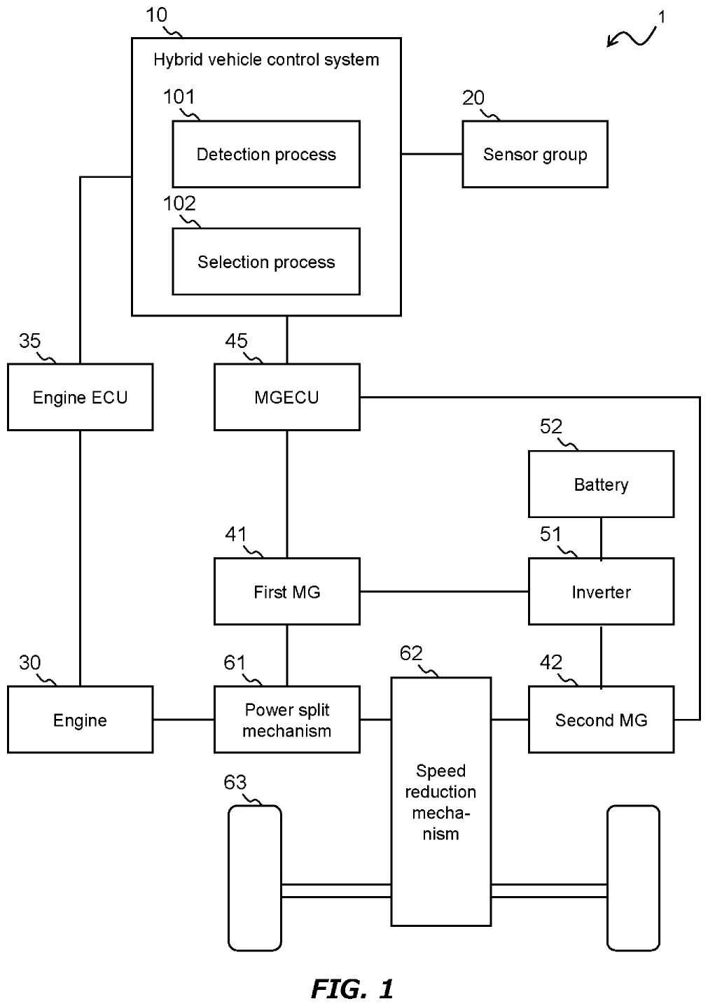

The hybrid vehicle control apparatus according to the present embodiment controls a hybrid vehicle. FIG. 1 is a block diagram schematically showing a configuration example of a vehicle 1 to which a hybrid vehicle control system 10 (hereinafter referred to as a control device 10) according to the present embodiment is applied.

The vehicle 1 is a hybrid vehicle that can travel by transmitting power of only a motor, power of only an engine, or power of an engine and a motor to driving wheels. The vehicle 1 includes a control device 10, a sensor group 20, an engine 30, an engine electronic control unit (ECU) 35, a first motor generator (first MG) 41, a second motor generator (second MG) 42, a motor generator ECU (MGECU) 45, inverters 51, a battery 52, a power split mechanism 61, a speed reduction mechanism 62, and driving wheels 63. Although not illustrated, the vehicle 1 is a vehicle that is equipped with an automatic driving system and can perform automatic driving.

The control device 10 is an ECU that is mounted on the vehicle 1 and controls a drive mode of the vehicle 1. The control device 10 is configured to be able to communicate information with the sensor group 20, the engine ECU35, and the MGECU45. For example, the control device 10 is connected to these devices via an in-vehicle network configured by a wire harness or the like. The control device 10 may be further configured to communicate information with an automatic driving system of the vehicle 1.

The sensor group 20 includes a recognition sensor, a vehicle state sensor, a position sensor, and the like. The recognition sensor recognizes the situation around the vehicle 1. Examples of the recognition sensor include an in-vehicle camera, a laser imaging detection and ranging (LIDAR), and a radar. The vehicle state sensor detects a state of the vehicle 1. Examples of the vehicular state sensor include a speed sensor, a acceleration sensor, a yaw rate sensor, a steering angle sensor, and a gear position sensor. The position sensor detects the position and the orientation of the vehicle 1. For example, the position sensor includes a global positioning system (GPS) sensor. The sensor group 20 may further include a battery sensor that detects the charge amount of the battery 52.

The control device 10 can acquire sensor information detected by the sensors by communicating with the sensor group 20.

The automatic driving system of the vehicle 1 is communicably connected to the sensor group 20. The automatic driving system communicates with the sensor group 20 to acquire sensor information detected by the sensor group 20 and control automatic driving of the vehicle 1.

For example, the automatic driving system of the vehicle 1 acquires the current position of the vehicle 1 by acquiring information from the position sensor of the sensor group 20. The autonomous driving system creates a travel plan to the destination based on the current position of the vehicle 1 and information such as the destination input by the user of the vehicle 1 and map information owned by the autonomous driving system.

The autonomous driving system recognizes the situation around the vehicle 1 by the recognition sensor of the sensor group 20 and generates a target trajectory of the vehicle 1 for traveling in accordance with the traveling plan on the basis of the recognition result. For example, the automatic driving system recognizes the situation around the vehicle 1 and the position of the white line by the recognition sensor, and generates a target trajectory for the vehicle 1 to travel while maintaining the traveling lane. Then, the autonomous driving system acquires the current vehicle speed and steering angle of the vehicle 1 from the vehicle state sensor, and determines the control amount of the vehicle 1 for following the target trajectory.

The 1MG41 and 2MG42 are motors capable of generating electric power. The 1MG41 and 2MG42 have both a function as a motor that outputs torque by supplied electric power and a function as a generator that converts input mechanical power into electric power. The 1MG41 is mainly used as a generator, and the 2MG42 is mainly used as a motor. The 1MG41 and 2MG42 transmit and receive electric power to and from the battery 52 via the inverters 51.

The engine 30, the 1MG41, and the 2MG42 are coupled to the drive wheels 63 via the power split mechanism 61 and the speed reduction mechanism 62. The power split mechanism 61 is, for example, a planetary gear unit, and splits the torque output from the engine 30 to a 1MG41 and the drive wheels 63. The 1MG41 regenerates electric power by the torque supplied from the engine 30 via the power split mechanism 61. The torque output from the engine 30 or the torque output from the 2MG42 is transmitted to the drive wheels 63 via the speed reduction mechanism 62.

The engine ECU35 is communicably connected to the engine 30 and controls the engine 30. The MGECU45 is communicably connected to the 1MG41 and the 2MG42 and controls the 1MG41 and the 2MG42.

The control device 10 can control the drive mode of the vehicle 1 by communicating with the 1MG41 and the 2MG42. The drive mode of the vehicle 1 includes an EV mode and an engine activation mode.

The EV mode is a mode in which the engine 30 is stopped and the vehicle 1 is driven by the power transmitted from the motor (1MG41 or 2MG42). The engine activation mode is a mode in which the engine 30 is operated. In the engine activation mode, the power generated by the engine 30 may be used to drive the vehicle 1, may be used to charge the battery 52 by causing the motor to generate electric power, or may be used for both of them.

The control device 10 executes detection processing 101 and selection processing 102 as processing related to the control of the drive mode.

In the detection process 101, when the situation currently faced by the vehicle 1 is a situation in which high accuracy is required for control in traveling, the control device 10 detects the situation as a “predetermined situation”. The high accuracy mentioned here means that an error in the control of the vehicle 1 is small. The specific contents of the detection process 101 will be described later.

In the selection process 102, the control device 10 selects the drive mode of the vehicle 1 based on the detection result of the detection process 101. Specifically, the control device 10 selects the EV mode when the situation currently faced by the vehicle 1 is the predetermined situation. On the other hand, the engine activation mode is selected only when the vehicle 1 is not currently in the predetermined situation.

The following describes the effect of the selection of the drive mode by the control device 10. As a Comparative example, selection of a drive mode in a general hybrid vehicle will be considered. As a method of selecting the drive mode in the hybrid vehicle, the drive mode is generally selected based on the state of charge (SOC) of the battery 52. Generally, the engine activation mode is selected when the SOC is smaller than a predetermined amount, and the EV mode is selected when the SOC is larger than the predetermined amount.

However, the difference between the two drive modes, i.e., the EV mode and the engine activation mode, affects not only the SOC. As one of the influences other than the SOC, the difference between the two drive modes may influence the control accuracy of the vehicle 1, that is, an error in the control.

When the engine 30 is operating, vibration is generated in the entire vehicle 1. The vibration is also transmitted to the sensor group 20, and there is a possibility that an error occurs in the sensor information detected by the sensor group 20. For example, the image captured by the in-vehicle camera may be blurred due to the vibration, and an error may occur between the position of the white line detected from the image and the actual position. Since the sensor information is used for controlling the vehicle 1, if an error occurs in the sensor information, an error also occurs in the control.

Further, when the engine 30 is used to drive the vehicle 1, the error of the control amount with respect to the operation amount is larger than when only the motor is used to drive the vehicle 1. The operation amount here means a current for the motor, and a throttle opening or a fuel injection amount for the engine 30. That is, in the case of the motor, the control amount can be linearly increased by linearly increasing the input current, whereas in the case of the engine 30, the control amount does not linearly increase with respect to the increase amount of the throttle opening or the fuel injection amount, and an error occurs in the control amount.

However, these errors are errors that do not affect the traveling in a scene in which the restriction on the operation of the vehicle 1 is small, such as when the vehicle 1 is traveling on a road with a sufficiently large road width. However, depending on the traveling place and the traveling scene of the vehicle 1, the restriction on the operation of the vehicle 1 may be increased. For example, when the vehicle 1 is parked, many obstacles exist in the surroundings and the direction in which the vehicle 1 can travel is limited, so it is necessary to accurately recognize the surrounding situation and finely adjust the vehicle speed and steering angle of the vehicle 1. In a situation where the restriction on the operation of the vehicle 1 is large as described above, there is a possibility that the control error affects the traveling of the vehicle 1.

That is, which of the EV mode and the engine activation mode is effectively selected may vary depending on whether the current situation of the vehicle 1 is a situation in which high control accuracy is required. When the current situation of the vehicle 1 is a situation in which the restriction on the operation of the vehicle 1 is large, that is, a situation in which high accuracy is required for the control of the vehicle 1, it is advantageous in the control of the vehicle 1 that the EV mode with a small error is selected. On the other hand, when the current situation of the vehicle 1 is a situation in which high accuracy is not required for control, there is no significant difference even if any drive mode is selected, at least from the viewpoint of control accuracy.

According to the detection process 101 and the selection process 102 executed by the control device 10, the drive mode is selected according to whether or not the current situation of the vehicle 1 is a situation in which high control accuracy is required for traveling. By selecting the EV mode in a situation where high control accuracy is required, the EV mode of the hybrid vehicle can be effectively utilized.

### 2. Example of Configuration

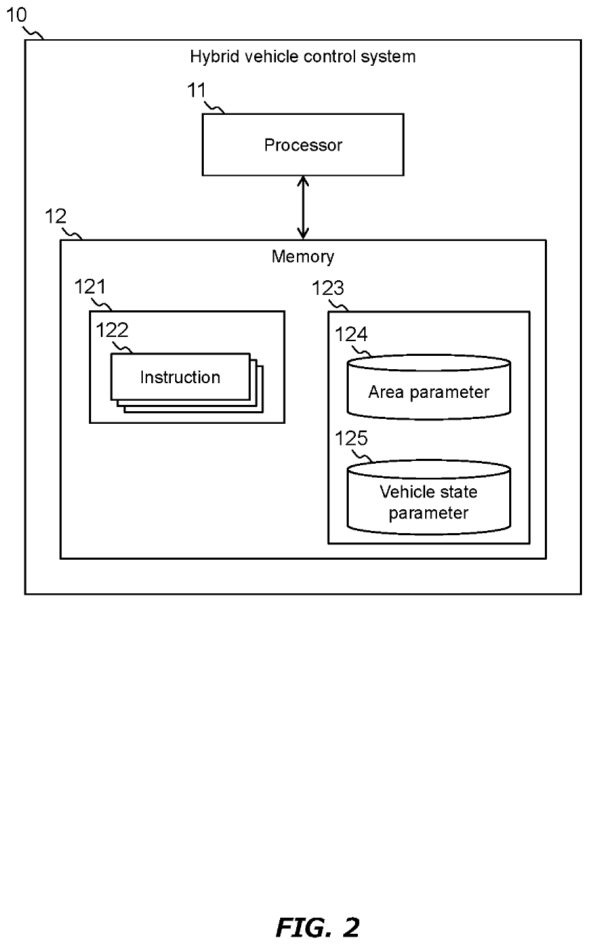

FIG. 2 shows an example of the configuration of the control device 10. The control device 10 is a computer including a processor 11 and a memory 12. The control device 10 may include a plurality of processors 11 and a plurality of memories 12.

The memory 12 is coupled to the processor 11 and stores a plurality of instructions 122 executable by the processor 11 and various data 123 necessary for execution of processing.

The plurality of instructions 122 are provided by the computer program 121. The plurality of instructions 122 are configured to cause the processor 11 to perform a detection process 101 and a selection process 102. That is, the processor 11 operates in accordance with the plurality of instructions 122, thereby implementing the detection process 101 and the selection process 102.

The data 123 includes information acquired by the control device 10 and parameter information of the computer program 121. For example, the data 123 includes the area parameter 124 or the vehicle state parameter 125.

The area parameter 124 and the vehicle state parameter 125 are parameter information for detecting a predetermined situation. The area parameter 124 is used in a first processing example described later, and the vehicle state parameter 125 is used in a second processing example described later. The area parameter 124 is parameter information for detecting a predetermined situation based on the traveling location of the vehicle 1, and defines a “predetermined area”. The vehicle state parameter 125 is information for detecting a predetermined state based on the vehicle state, and designates a “predetermined state”. The predetermined area and the predetermined state will be described later. The data 123 may further include map information.

### 3. Example of Processing

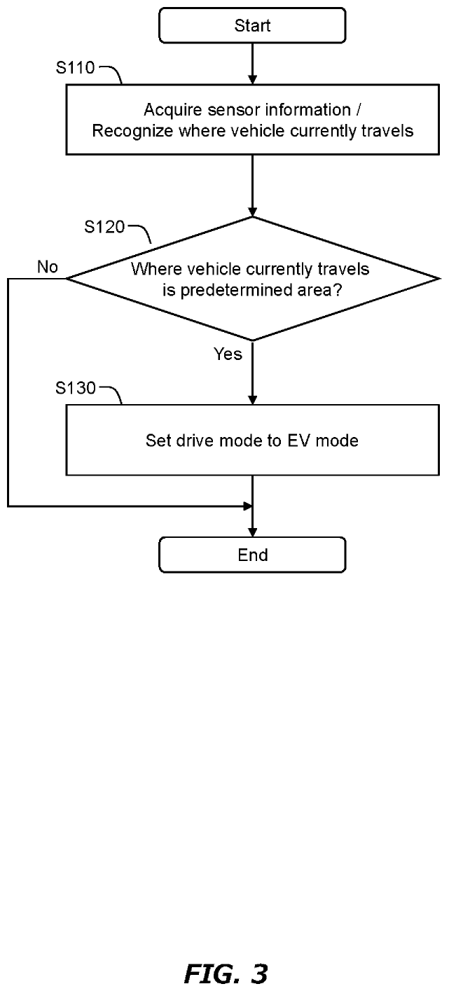

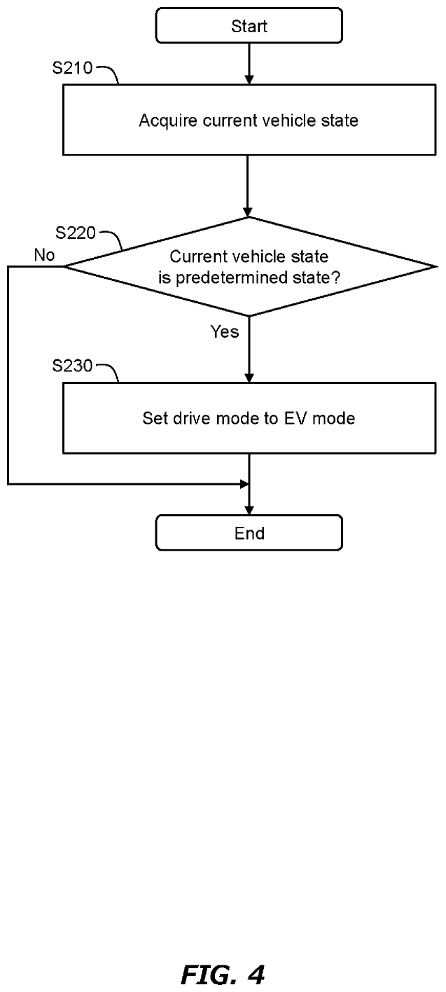

An example of the process executed by the control device 10 will be described with reference to FIGS. 3 and 4. The processes illustrated in FIGS. 3 and 4 are realized by the processor 11 operating in accordance with the plurality of instructions 122. These processes are started, for example, at the start of the operation of the vehicle 1 and are repeatedly executed at predetermined intervals.

FIG. 3 is a flowchart showing a first processing example. In a first example, the control device 10 detects the predetermined situation when the place where the vehicle 1 is currently traveling is the predetermined area. The predetermined area is an area in which high accuracy is required for the control of the vehicle 1. Examples of the predetermined area include a parking lot, a road having a road width equal to or smaller than a threshold, a road surface curved with a curvature equal to or larger than a threshold, an urban area, and an area where a charging facility is installed. For example, in a parking lot, it is required to accurately recognize the surrounding situation and perform control so as not to come into contact with other vehicles parked in the surrounding area. Alternatively, for example, in a narrow road where the road width is equal to or less than a threshold value, the vehicle 1 is required to travel at a low speed while finely adjusting the steering angle so as not to deviate from the road. Alternatively, for example, in an urban area, it is expected that obstacles such as people and bicycles are increased around the vehicle 1, and thus it is required to accurately recognize the position of the obstacle and perform control. Alternatively, for example, in an area where a charging facility is installed, vehicle 1 is required to accurately park and stop in accordance with the position of the charging facility. Therefore, it is considered that high control accuracy is required when the vehicle 1 is traveling in such an area.

In step S110, the control device 10 recognizes the current traveling location of the vehicle 1. The control device 10 can recognize the current traveling location of the vehicle 1 by acquiring information from the recognition sensors of the sensor group 20. For example, the control device 10 can calculate the curvature of the road surface and the road width by recognizing the white line of the lane on which the vehicle 1 travels by the in-vehicle camera. Alternatively, for example, the control device 10 detects a target around the vehicle 1 by a camera or LiDAR. When the number of pedestrians detected around the vehicle 1 is equal to or greater than a predetermined number, the traveling location is recognized as an urban area.

In step S120, the control device 10 determines whether or not the current traveling location of the vehicle 1 is in the predetermined area. The control device 10 can determine whether or not the current traveling location of the vehicle 1 recognized in step S110 is the predetermined area by using the area parameter 124. When the current traveling place is the predetermined area (Yes in step S120), the process proceeds to step S130. On the other hand, when the current traveling location is not in the predetermined area (step S120; No), the current process is terminated.

In step S130, the control device 10 sets the drive mode of the vehicle 1 to the EV mode. When the current drive mode of the vehicle 1 is the engine activation mode, the control device 10 changes the drive mode to the EV mode. When the current drive mode of the vehicle 1 is already the EV mode, the drive mode is not changed. When the drive mode is set to the EV mode, the current process is terminated.

Steps S110 and S120 shown in FIG. 3 are an example of the detection process 101 based on the traveling location of the vehicle 1. As another example, the predetermined situation may be detected using map information included in the data 123. For example, the map information includes road features such as road width and curvature, and information on an area with many people such as an urban area, which are registered in advance. The control device 10 acquires the current position of the vehicle 1 from the position sensor of the sensor group 20. Then, the control device 10 collates the acquired current position with the map information to acquire the current position of the vehicle 1, and if the vehicle 1 is traveling on a road, the control device 10 acquires the width and curvature of the road on which the vehicle 1 is traveling. The control device 10 determines whether the current traveling location of the vehicle 1 is in the predetermined area based on the information acquired using the map information in this way.

Alternatively, information indicating the predetermined area may be registered in the map information in advance. In this case, the control device 10 acquires the current position of the vehicle 1 from the position sensor. Then, the acquired current position is compared with the map information, and when the vehicle 1 is in the predetermined area, the predetermined situation is detected.

As still another example of the detection process 101, the control device 10 may acquire information on the travel plan of the vehicle 1 by communicating with the automatic driving system. When the travel plan indicates that the vehicle 1 will be parked in the near future, the travel location of the vehicle 1 may be determined to be a parking lot.

FIG. 4 is a flowchart showing a second example of the process performed by the control device 10. In a second example, the control device 10 detects the predetermined situation when the current vehicle state of the vehicle 1 is the predetermined state. The predetermined state is a state in which high accuracy is required for the control of the vehicle 1. Examples of the predetermined state include a state where the steering angle is larger than a threshold value, a state where the rate of change in the steering angle is larger than a threshold value, a state where the vehicle speed is lower than a threshold value, and a state where the vehicle 1 is traveling backward. When the steering angle or the rate of change in the steering angle is larger than the threshold value, or when the vehicle 1 is traveling at a low speed, there is a high possibility that the vehicle 1 is traveling in a place where high control accuracy is required, such as a narrow road or a mountain road. Similarly, when the vehicle 1 is traveling backward, the vehicle 1 is likely to be performing an operation that requires high control accuracy, such as when the vehicle 1 is parked. Therefore, it is considered that high control accuracy is required when the vehicle state is such a state.

In step S210, the control device 10 acquires information about the current state of the car from the car state sensors of the sensor group 20. For example, the control device 10 acquires information on the current steering angle of the vehicle 1 from the steering angle sensor. Alternatively, for example, the control device 10 acquires information on the current vehicle speed of the vehicle 1 by a vehicle speed sensor. Alternatively, for example, the control device 10 acquires information on whether or not the gear is in the reverse gear from the gear position sensor.

In step S220, the control device 10 determines whether the current state of the vehicle 1 is the predetermined state. The control device 10 can determine whether the current vehicular state acquired in step S210 is the predetermined state by using the vehicular state parameter 125. When the current vehicular state is the predetermined state (step S220; Yes), the process proceeds to step S230. On the other hand, when the current vehicular state is not the predetermined state (step S220; No), the current process is ended.

In step S230, the control device 10 sets the drive mode of the vehicle 1 to the EV mode. When the current drive mode of the vehicle 1 is the engine activation mode, the control device 10 changes the drive mode to the EV mode. When the current drive mode of the vehicle 1 is already the EV mode, the drive mode is not changed. When the drive mode is set to the EV mode, the current process is terminated.

Steps S210 and S220 shown in FIG. 4 are examples of the detection process 101 based on the vehicular state. As another example of the detection process 101, the control device 10 may communicate with an automatic driving system to acquire a target steering angle or a target vehicle speed by the automatic driving system. The predetermined state may be detected when the target steering angle is larger than a threshold value, or when the target vehicle speed is smaller than a threshold value.

Two examples of the process performed by the control device 10 have been described above. In the first processing example, the predetermined situation is detected based on the current traveling location of the vehicle 1. In the second processing example, the predetermined situation is detected based on the current vehicle state. In any of the processing examples, when the vehicle 1 is currently in a situation where high control accuracy is required, the EV mode is selected. Thus, the EV mode of the hybrid vehicle 1 can be effectively utilized.

### 4. Other Examples of Configuration

A vehicle 1 shown in FIG. 1 is a so-called series-parallel hybrid vehicle. However, the vehicle 1 may be any hybrid vehicle, and is not limited to a series-parallel hybrid vehicle. For example, the vehicle 1 may be a series hybrid vehicle. The series hybrid vehicle is a hybrid vehicle in which the engine is separated from the drive system and is used only for power generation of the motor. Alternatively, the vehicle 1 may be a hybrid vehicle in which a motor is used as an auxiliary role of an engine, such as a parallel hybrid vehicle or a mild hybrid vehicle.

In the above example, the vehicle 1 is an automatically driven vehicle. However, the vehicle 1 is not limited to the automatic driving vehicle, and may be, for example, a remote driving vehicle. In the case of a remotely operated vehicle, the error of the control amount with respect to the operation amount is larger when the vehicle is driven by the engine 30. Further, the occurrence of vibration in the sensor group 20 may cause an error in information transmitted to a remote operator who remotely operates the vehicle 1. Therefore, similarly, it is effective that the EV mode is selected when the predetermined situation is detected.

Alternatively, the vehicle 1 may be a vehicle manually driven by the driver. The fact that the error of the control amount with respect to the operation amount is larger when the engine 30 is used to drive the vehicle 1 than when the vehicle 1 is driven only by the motor is the same as when the vehicle 1 is driven by the driver. Further, for example, when the driver parks the vehicle while checking an image captured by the back camera of the in-vehicle camera, the vibration of the engine is eliminated and the shake of the camera is reduced, and thus, an effect of improving the accuracy of the control of the vehicle 1 by the driver is expected. However, the sensor information in the control of the vehicle 1 has a larger weight when the vehicle 1 is an automatically driven vehicle or a remotely driven vehicle. In particular, in the autonomous driving vehicle, since the vehicle 1 is controlled using various sensor information, reducing the vibration of the sensor group 20 is more effective in improving the control accuracy of the vehicle 1. Therefore, the control device 10 is more effective when applied to the autonomous driving vehicle.

What is claimed is:

1. A hybrid vehicle control system for controlling a vehicle having a motor and an engine comprising:
at least one processor; and
at least one memory coupled with the at least one processor and storing a plurality of instructions,
wherein the plurality of instructions is configured to cause the at least one processor to execute:
determining whether a situation which the vehicle is currently facing is a situation in which high accuracy is required for control of driving of the vehicle or not;
selecting only an EV mode under a situation in which high accuracy is required for the control, the EV mode being a mode in which the engine is stopped and the vehicle is driven by the motor; and
selecting an engine activation mode only under a situation in which high accuracy is not required for the control, the engine activation mode being a mode in which the engine is activated for at least one of power generation for charging a battery and driving the vehicle.

2. The hybrid vehicle control system according to claim 1, wherein the situation in which high accuracy is required for the control includes a situation in which the vehicle drives in at least one of a parking place, a road having a width equal to or smaller than a threshold value, and a road curved at a curvature equal to or larger than a threshold value.

3. The hybrid vehicle control system according to claim 1, wherein the situation in which high accuracy is required for the control includes at least one of a situation in which a steering angle of the vehicle is larger than a threshold value, a situation in which a vehicle speed of the vehicle is lower than a threshold value, and a situation in which the vehicle is driving backward.

4. The hybrid vehicle control system according to claim 1, wherein the vehicle is an autonomous vehicle or a remotely driven vehicle.

5. A method for controlling a hybrid vehicle having a motor and an engine, the method comprising:
determining whether a situation which the hybrid vehicle is currently facing is a situation in which high accuracy is required for control of driving of the hybrid vehicle or not;
selecting only an EV mode under a situation in which high accuracy is required for the control, the EV mode being a mode in which the engine is stopped and the hybrid vehicle is driven by the motor; and
selecting an engine activation mode only under a situation in which high accuracy is not required for the control, the engine activation mode being a mode in which the engine is activated for at least one of power generation for charging a battery and driving the hybrid vehicle.
